(19) United States
(12) Patent Application Publication
(10) Pub. No.: US 2025/0065953 A1
(43) Pub. Date: Feb. 27, 2025

(54) AN APPARATUS FOR THE STATIONING OF A LOCOMOTORY DEVICE FROM OUTSIDE THE LOCOMOTORY DEVICE

(71) Applicant: Gensol Electric Vehicles Private Limited, Pune (IN)

(72) Inventor: Pratik Gupta, Mumbai (IN)

(73) Assignee: Gensol Electric Vehicles Private Limited, Pune, MH (IN)

(21) Appl. No.: 18/727,762

(22) PCT Filed: Feb. 6, 2023
(86) PCT No.: PCT/IN2023/050117

§ 371 Date: Jul. 10, 2024

(30) Foreign Application Priority Data
Feb. 7, 2022 (IN) 202221006465

(51) Int. Cl. B62D 15/02; B60W 30/06; B60W 30/095; G08G 1/14

(52) U.S. Cl. CPC B62D 15/0285; B60W 30/06; B60W 30/0956; G08G 1/14

(57) ABSTRACT

An apparatus, for the stationing of a locomotory device, from outside the locomotory device, is disclosed. Said apparatus broadly comprises: an at least a sensing member; and an at least a control member. Said at least one sensing member facilitates sensing of an at least a parameter, of a locomotory device (101) to be stationed, in real-time. Said at least one sensing member is communicatively associated with an at least a visual interfacing member (105). Said at least one control member is configured to facilitate monitoring and controlling of said apparatus. Said at least one control member is associated with said at least one visual interfacing member (105). Said apparatus also comprises an alert generating member that generates an at least an alert. The disclosed apparatus offers at least the following advantages: is simple in construction; is cost-effective; may be configured to be retrofitted (onto existing locomotory devices); and facilitates safe stationing of locomotory devices.

### FIELD OF THE INVENTION

The present disclosure is generally related to locomotory devices. Particularly, the present disclosure is related to the stationing of locomotory devices. More particularly, the present disclosure is related to an apparatus, for the stationing of a locomotory device, from outside the locomotory device.

### BACKGROUND OF THE INVENTION

Stationing of locomotory devices is to be done, in a safe and correct manner. A stationed locomotory device should not: obstruct other locomotory devices that are around it; obstruct traffic flow; obstruct pedestrians, on a path, where it is stationed; be damaged, by nearby objects, on the path, where it is stationed; and damage other locomotory devices and objects, which are around it.

Stationing in an efficient manner can be difficult, due to lack of vision, from inside a cabin of the locomotory device (to be stationed). Footpath borders, road dividers, other objects, and locomotory devices near the stationing space, make safe and correct stationing tedious and cumbersome.

It is observed that correct stationing leaves no room (for opening of the stationed locomotory device). As a result, entry and exit become very difficult. This is especially true, in congested areas, with tight stationing spaces. This causes wastage of stationing spaces, as locomotory devices are stationed, to ensure comfortable entry and exit.

Current technologies that offer stationing assistance are: expensive; greatly complex; and require sophisticated systems, to process data, in real-time.

There is, therefore, a need in the art, for an apparatus, for the stationing of a locomotory device, from outside the locomotory device, which overcomes the aforementioned drawbacks and shortcomings.

### SUMMARY OF THE INVENTION

An apparatus, for the stationing of a locomotory device, from outside the locomotory device, is disclosed. Said apparatus broadly comprises: an at least a sensing member; an at least a visual interfacing member; an at least a control member; and an alert generating member.

Said at least one sensing member may be communicatively associated with a locomotory device. Said at least one sensing member facilitates sensing of an at least a parameter, of said locomotory device to be stationed (or an at least a parameter, which is associated with said locomotory device to be stationed), in real-time.

Said at least one sensing member includes: an at least a radio detection and ranging sensing member; an at least a sound navigation and ranging sensing member; and/or an at least an image capturing member.

In an embodiment, said at least one parameter includes: distance and/or direction of objects, surrounding said locomotory device to be stationed.

Said at least one radio detection and ranging sensing member, and/or said at least one sound navigation and ranging sensing member, sense objects, in real-time, along (or in the vicinity of, or in the proximity of) a stationing path, to be taken, by said locomotory device. Sensed data is transmitted, to said at least one visual interfacing member and/or said at least one control member.

Said at least one image capturing member, on the other hand, senses visual signals (parking lines, parking signs, and/or the like), in real-time. An at least a user or operator views sensed data, through said at least one visual interfacing member.

Said at least one sensing member is communicatively associated with said at least one visual interfacing member. Said at least one visual interfacing member is configured to act as an interface, between said locomotory device to be stationed and said at least one user or operator. Said at least one parameter that is (or are) sensed, by said at least one sensing member, is (or are) transmitted, to said at least one visual interfacing member.

Said at least one control member facilitates controlling of said locomotory device. Said at least one control member is communicatively associated with a plurality of actuators, including: brakes; accelerator, steering; and gear (or gearbox). Said at least one control member may be disposed on (or may be disposed at, or may be disposed in, or may be disposed within, or may be associated with) said at least one visual interfacing member.

Controlling of said gear broadly comprises: a first gear control; a neutral gear control; and/or a reverse gear control. Said first gear control, said neutral gear control, and said reverse gear control, are actuated, through said at least one visual interfacing member and/or said at least one control member.

Controlling of said accelerator (or accelerator control) involves (or broadly comprises) controlling of intensity and/or duration, for which, an accelerator pedal is applied. Said accelerator control is actuated, through said at least one visual interfacing member and/or said at least one control member. Said accelerator control is configured to be actuated, only when said locomotory device to be stationed is in first gear or in reverse gear.

By default, a brake control is configured to actuated, until said accelerator control is actuated. Controlling of said brakes involves (or broadly comprises) controlling of intensity and/or duration, for which, said brakes are applied. Said brake control is actuated, through said at least one visual interfacing member and/or said at least one control member.

Controlling of said steering (or steering control) involves (or broadly comprises) controlling of a steering's angle of rotation and/or direction of rotation.

Said plurality of actuators also includes actuators, which are controlled, through ON/OFF commands, including, but not limited to: parking lights; locking system; hand brake; ignition; and/or the like.

Based on said data received, by said at least one visual interfacing member and/or said at least one control member, and viewed, through said at least one visual interfacing member, said at least one user or operator operates said locomotory device to be stationed, through said at least one control member.

Said alert generating member generates an at least an alert, to said at least one user or operator. Said alert generating member is communicatively associated with said at least one control member. Said at least one alert is generated, by said alert generating member, upon said at least one control member's instructions.

The disclosed apparatus offers at least the following advantages: is simple in construction; is cost-effective (may cost about Rs. 30,000); may be configured to be retrofitted (onto existing locomotory devices); and facilitates safe stationing of locomotory devices.

### BRIEF DESCRIPTION OF THE DRAWINGS

FIG. 1 illustrates an apparatus, for the stationing of a locomotory device, from outside the locomotory device, in accordance with an embodiment of the present disclosure;

FIG. 2 illustrates a method of operation, of an apparatus, for the stationing of a locomotory device, from outside the locomotory device, in accordance with an embodiment of the present disclosure; and

FIG. 3 illustrates an at least a visual interfacing member, of an apparatus, for the stationing of a locomotory device, from outside the locomotory device, in accordance with an embodiment of the present disclosure

### DETAILED DESCRIPTION OF THE INVENTION

Throughout this specification, the use of the words “comprise” and “include”, and variations, such as “comprises”, “comprising”, “includes”, and “including”, may imply the inclusion of an element (or elements) not specifically recited. Further, the disclosed embodiments may be embodied, in various other forms, as well.

Throughout this specification, the use of the word “apparatus” is to be construed as: “a set of technical components (also referred to as “members”) that are communicatively and/or operably associated with each other, and function together, as part of a mechanism, to achieve a desired technical result”.

Throughout this specification, the use of the words “communication”, “couple”, and their variations (such as communicatively), is to be construed as being inclusive of: one-way communication (or coupling); and two-way communication (or coupling), as the case may be, irrespective of the directions of arrows, in the drawings.

Throughout this specification, where applicable, the use of the phrase “at least” is to be construed in association with the suffix “one” i.e. it is to be read along with the suffix “one”, as “at least one”, which is used in the meaning of “one or more”. A person skilled in the art will appreciate the fact that the phrase “at least one” is a standard term that is used, in Patent Specifications, to denote any component of a disclosure, which may be present (or disposed) in a single quantity, or more than a single quantity.

Throughout this specification, the use of the word “plurality” is to be construed as being inclusive of: “at least one”.

Throughout this specification, the use of the word “stationing”, and its variations, is to be construed as being inclusive of: “parking, in a parking space; and/or exiting, from a parking space, as the case may be”. A person skilled in the art will appreciate the fact that what is considered to be safe stationing will depend on factors that include, but are not limited to: country-specific legislations; place of stationing; time of stationing; and/or the like.

Throughout this specification, the use of the phrase “stationing space”, and its variations, is to be construed as: “parking space; and/or the like”.

Throughout this specification, the use of the phrase “locomotory device”, and its variations, is to be construed as being inclusive of: “three wheeled vehicles; four wheeled vehicles; and/or higher wheeled vehicles”.

Throughout this specification, the use of the phrase “application on a computing device”, and its variations, is to be construed as being inclusive of: application installable on a computing device; website hosted on a computing device; web application installed on a computing device; website accessible from a computing device; and/or web application accessible from a computing device.

Throughout this specification, the use of the phrase “computing device”, and its variations, is to be construed as being inclusive of: the cloud; remote servers; desktop computers; laptop computers; mobile phones; smart phones; tablets; phablets; and/or smart watches.

Throughout this specification, the use of the acronym “RADAR” is to be construed as: “Radio Detection and Ranging”.

Throughout this specification, the use of the acronym “SONAR” is to be construed as: “Sound Navigation and Ranging”.

Throughout this specification, the use of the phrase “front camera” is to be construed as: “an image capturing member, which is associated with a front portion (or is disposed on a front portion, or is disposed at a front portion), of a locomotory device to be stationed”.

Throughout this specification, the use of the phrase “back camera” is to be construed as: “an image capturing member, which is associated with a back portion or rear portion (or is disposed on a back portion or rear portion, or is disposed at back portion or rear portion), of a locomotory device to be stationed”.

Throughout this specification, the use of the phrase “locomotory device to be stationed” is to be construed as: “locomotory device that is to be stationed”.

Throughout this specification, the disclosure of a range is to be construed as being inclusive of: the lower limit of the range; and the upper limit of the range.

Throughout this specification, the words “the” and “said” are used interchangeably.

Throughout this specification, the phrases “at least a”, “at least an”, and “at least one” are used interchangeably.

Throughout this specification, the words “apparatus” and “system” are used interchangeably.

Throughout this specification, the word “sensor” and the phrase “sensing member” are used interchangeably. The disclosed sensing members may be of any suitable type known in the art.

Throughout this specification, the word “camera” and the phrase “image capturing member” are used interchangeably.

Throughout this specification, where applicable, the phrase “locomotory device” and the phrase “locomotory device to be stationed” are used interchangeably.

Throughout this specification, the phrase “locomotory device to be stationed” and the word “vehicle” are used interchangeably.

Throughout this specification, the phrase “control member” and the word “processor” are used interchangeably. Alternatively, the processor may be disposed in (or may be disposed within, or may be associated with) the control member.

Throughout this specification, the phrase “visual interfacing member” and the word “dashboard” are used interchangeably.

Also, it is to be noted that embodiments may be described as a method. Although the operations, in a method, are described as a sequential process, many of the operations may be performed in parallel, concurrently, or simultaneously. In addition, the order of the operations may be re-arranged. A method may be terminated, when its operations are completed, but may also have additional steps.

An apparatus, for the stationing of a locomotory device, from outside the locomotory device (also referred to as “apparatus”), is disclosed. In an embodiment of the present disclosure, the apparatus broadly comprises an at least a sensing member that may be communicatively associated with a locomotory device (101). The at least one sensing member facilitates sensing of an at least a parameter, of the locomotory device (101) to be stationed (or an at least a parameter, which is associated with said locomotory device (101) to be stationed), in real-time.

In another embodiment of the present disclosure, the at least one sensing member includes, but is not limited to: an at least a motion sensing member; an at least a pot-hole sensing member; an at least an acceleration sensing member; an at least a radio detection and ranging sensing member (102); an at least a sound navigation and ranging sensing member (103); and/or an at least an image capturing member (104).

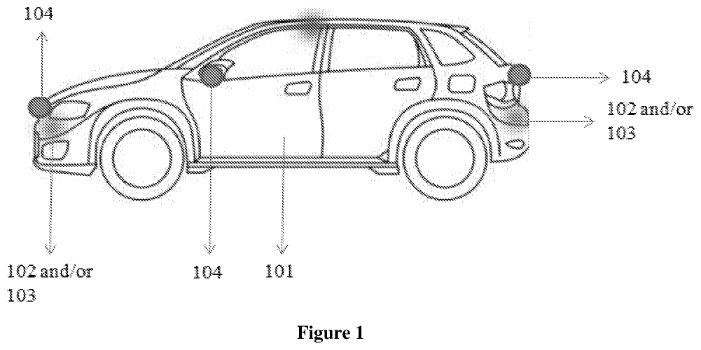

In yet another embodiment of the present disclosure, as illustrated, in FIG. 1, the at least one sensing member includes, but is not limited to: the at least one radio detection and ranging sensing member (102); the at least one sound navigation and ranging sensing member (103); and/or the at least one image capturing member (104).

The at least one radio detection and ranging sensing member (102), and/or the at least one sound navigation and ranging sensing member (103), sense objects, in real-time, along (or in the vicinity of, or in the proximity of) a stationing path, to be taken, by the locomotory device (101).

The at least one image capturing member (104), on the other hand, senses visual signals (parking lines, parking signs, and/or the like), in real-time. A person skilled in the art will appreciate the fact that the at least one image capturing member (104) may be of any suitable type known in the art.

In yet another embodiment of the present disclosure, the at least one parameter includes, but is not limited to: distance and/or direction of objects, surrounding the locomotory device (101) to be stationed.

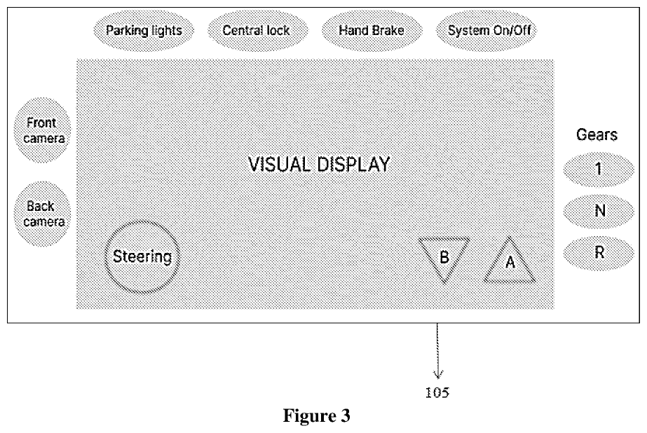

The at least one sensing member is communicatively associated with an at least a visual interfacing member (105; for example, a joystick with display, or application on a computing device, as illustrated, in FIG. 3) that is configured to act as an interface, between the locomotory device (101) to be stationed and an at least a user or operator. The at least one parameter (data) that is (or are) sensed, by the at least one sensing member, is (or are) transmitted, to the at least one visual interfacing member (105).

Based on the data received, by the at least one visual interfacing member (105) and/or said at least one control member, and viewed, through the at least one visual interfacing member (105), the at least one user or operator operates the locomotory device (101) to be stationed, through an at least a control member that is configured to facilitate controlling of the locomotory device (101).

The at least one control member may be disposed on (or may be disposed at, or may be disposed in, or may be disposed within, or may be associated with) the at least one visual interfacing member (105).

In yet another embodiment of the present disclosure, the at least one control member is a microcontroller.

In yet another embodiment of the present disclosure, the at least one control member is a Single Board Computer.

In yet another embodiment of the present disclosure, the at least one control member is a System on Chip.

The at least one control member is communicatively associated with the locomotory device (101). Through the at least one control member, the at least one user or operator; switches on the locomotory device (101); switches off the locomotory device (101); and/or manoeuvres the locomotory device (101), from outside the locomotory device (101).

The at least one control member analyses (and/or processes) the data received, from the at least one sensing member, and transmits instructions, to the apparatus, to station the locomotory device (101).

The apparatus also comprises an alert generating member that generates an at least an alert, to the at least one user or operator. The alert generating member is communicatively associated with the at least one control member.

For example, an alert is generated, if the apparatus determines that an obstruction or object has been sensed, within a threshold distance (for example, about 1 metre), from the locomotory device (101) to be stationed.

In yet another embodiment of the present disclosure, the apparatus is configured, monitored, and controlled remotely, by the at least one user or operator, through the application on a computing device. The at least one user or operator interacts, with the apparatus, through a user interface (or display) of the computing device, which functions as an interface.

The at least one parameter that is sensed, by the at least one sensing member, is also transmitted, to the application on a computing device. The at least one alert is also generated, through the application on a computing device. The at least one alert may be of any type known in the art, including, but not limited to: text messages; voice calls; alarms; buzzers; and/or the like.

Communicative association with the at least one visual interfacing member (105) may occur, through wired or wireless technologies, such as: intranet; internet; mobile data; Bluetooth Low Energy; LoRa; ZigBee; and/or the like.

In yet another embodiment of the present disclosure, the at least one control member is configured to be self-learning; it utilises information gathered, during previous stationings, to improve its performance and efficiency.

An extensive (or full-fledged knowledge base) is stored on the cloud, with a refined version of the knowledge base (or a fine-tuned version of the knowledge base, or a minimalistic version of the knowledge base, or a compressed version of the knowledge base, or a pruned version of the knowledge base) being stored on the at least one control member.

The knowledge base on the cloud syncs, at regular, periodic intervals, with the at least one control member, and is configured to learn and improve itself, based on the data received continuously, from the at least one control member.

A person skilled in the art will appreciate the fact that the apparatus may be powered, by an at least a power source. The at least one power source may be of any suitable type known in the art. For example, the at least one power source is a rechargeable battery.

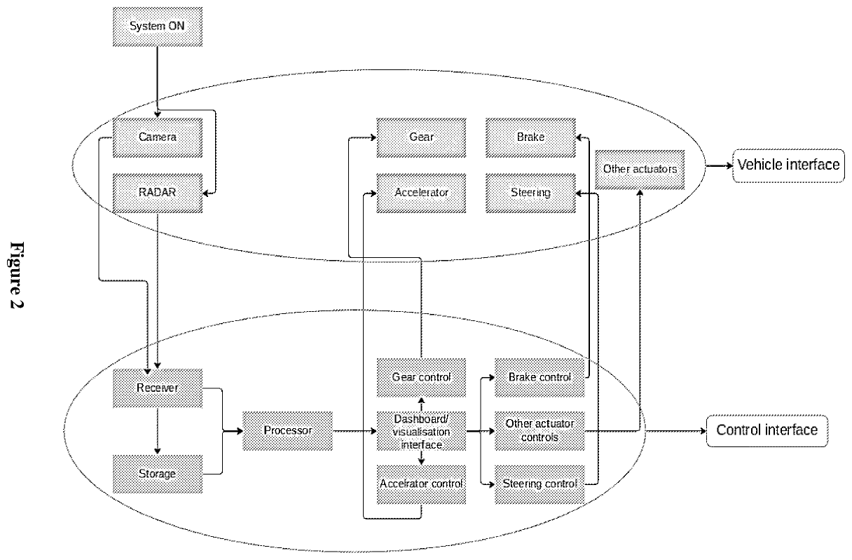

FIG. 2 illustrates a method of the apparatus's operation. Once the apparatus is switched on, the at least one radio detection and ranging sensing member (102); the at least one sound navigation and ranging sensing member (103); and/or the at least one image capturing member (104), sense: the distance and/or direction of objects, surrounding the locomotory device (101) to be stationed, in real-time, with the sensed data being transmitted, to the at least one visual interfacing member (105) and/or the at least one control member.

The data transmitted, by the at least one radio detection and ranging sensing member (102), and/or the at least one sound navigation and ranging sensing member (103), is (or are) showcased as visual 2D imagery (for example, through a floor map creating tool) that illustrate outlines of the locomotory device (101) to be stationed and detected objects. The at least one control member, in turn, is communicatively associated with a plurality of actuators, which include, but are not limited to: brakes; accelerator; steering; and gear (or gearbox).

Controlling of the gear (or gear control) broadly comprises: a first gear control (1; FIG. 3); a neutral gear control (N; FIG. 3); and/or a reverse gear control (R; FIG. 3). The first gear control (1; for example, a button), the neutral gear control (N; for example, a button), and the reverse gear control (R; for example, a button), are actuated, through the at least one visual interfacing member (105) and/or the at least one control member.

Likewise, controlling of the brakes involves (or broadly comprises) controlling of intensity and/or duration, for which, the brakes are applied. The time, for which, the brakes are applied, is equal to a time, for which, a brake control (B; FIG. 3) is actuated. The intensity, for which, the brakes are applied, is equal to twice the time, for which, the brake control (B; for example, a button) is actuated. The brake control (B) is actuated, through the at least one visual interfacing member (105) and/or the at least one control member.

Along similar lines, controlling of the accelerator (or accelerator control) involves (or broadly comprises) controlling of intensity and/or duration, for which, an accelerator pedal is applied. The time, for which, the accelerator pedal is applied, is equal to a time, for which, an accelerator control (A; FIG. 3) is actuated. The intensity, for which, the accelerator pedal is applied, is equal to twice the time, for which, the accelerator control (A; for example, a button) is actuated.

The accelerator control (A) is actuated, through the at least one visual interfacing member (105) and/or the at least one control member. The accelerator control (A) is configured to be actuated, only when the locomotory device (101) to be stationed is in the first gear or in the reverse gear.

By default, the brake control (B) is configured to actuated, until the accelerator control (A) is actuated. Depending on whether the locomotory device (101) to be stationed is in the first gear or in the reverse gear, the locomotory device (101) is instructed, by the at least one control member, to move forwards or backwards, respectively, upon actuation of the accelerator control (A).

If the distance, between the locomotory device (101) and the detected objects, is determined as being lesser than the threshold distance (for example, about 1 metre), the at least one control member transmits instructions, to the locomotory device (101), to stay in its place, with the at least one alert being generated, to the at least one user or operator.

On the other hand, if the distance, between the locomotory device (101) and the detected objects, is determined as being greater than the threshold distance (for example, about 1 metre), the at least one control member transmits instructions, to the locomotory device (101), to move forwards or backwards.

Similarly, controlling of the steering (or steering control) involves (or broadly comprises) controlling of a steering's angle of rotation and/or direction of rotation. The angle of rotation is determined, as follows: Angle=π*time, for which, a steering control is actuated. The steering control is actuated, through the at least one visual interfacing member (105) and/or the at least one control member.

Before instructing the locomotory device (101), to turn right or left, the at least one control member determines if there any objects that have been sensed, by the at least one radio detection and ranging sensing member (102), and/or the at least one sound navigation and ranging sensing member (103).

If the distance, between the locomotory device (101) and the detected objects, is determined as being lesser than the threshold distance (for example, about 1 metre), the at least one control member transmits instructions, to the locomotory device (101), to stay in its place, with the at least one alert being generated, to the at least one user or operator.

On the other hand, if the distance, between the locomotory device (101) and the detected objects, is determined as being greater than the threshold distance (for example, about 1 metre), the at least one control member transmits instructions, to the locomotory device (101), to turn right or left.

The plurality of actuators also includes actuators, which are controlled, through ON/OFF commands, including, but not limited to: parking lights; locking system; hand brake; ignition; and/or the like.

At all stages, during a stationing process, the at least one user or operator views the detected objects, through the data sensed, by the at least one image capturing member (104). The at least one user or operator can also determine, if a detected object is stationary, is moving towards the locomotory device (101) to be stationed, or is moving away, from the locomotory device (101) to be stationed.

In yet another embodiment of the present disclosure, a safe predetermined speed, of the locomotory device (101) to be stationed, ranges between about 0 km/hr and about 10 km/hr.

The disclosed apparatus offers at least the following advantages: is simple in construction; is cost-effective (may cost about Rs. 30,000); may be configured to be retrofitted (onto existing locomotory devices); and facilitates safe stationing of locomotory devices.

A person skilled in the art will appreciate the fact that the apparatus, and its various components, may be made of any suitable materials known in the art. Likewise, a person skilled in the art will also appreciate the fact that the configurations of the apparatus, and its various components, may be varied, based on requirements.

Implementation of the disclosure can involve performing or completing selected tasks manually, automatically, or a combination thereof. Further, according to actual instrumentation of the disclosure, several selected tasks could be implemented, by hardware, by software, by firmware, or by a combination thereof, using an operating system.

For example, as software, selected tasks according to the disclosure could be implemented. as a plurality of software instructions being executed, by a computing device, using any suitable operating system.

In yet another embodiment of the disclosure, one or more tasks, according to embodiments of the disclosure, is (or are) performed, by a data processor, such as a computing platform, for executing a plurality of instructions. Further, the data processor includes a processor, and/or non-transitory computer-readable medium, for storing instructions and/or data, and/or a non-volatile storage, for storing instructions and/or data. A network connection, a display, and/or a user input device such as a keyboard (or mouse) are also provided.

It will be apparent to a person skilled in the art that the above description is for illustrative purposes only and should not be considered as limiting. Various modifications, additions, alterations, and improvements, without deviating from the spirit and the scope of the disclosure, may be made, by a person skilled in the art. Such modifications, additions, alterations, and improvements should be construed as being within the scope of this disclosure.

### LIST OF REFERENCE NUMERALS

101—Locomotory Device
102—At Least One Radio Detection and Ranging Sensing Member
103—At Least One Sound Navigation and Ranging Sensing Member
104—At Least One Image Capturing Member
105—At Least One Visual Interfacing Member

We claim:

1. An apparatus, for the stationing of a locomotory device, from outside the locomotory device, comprising:
an at least a sensing member, said at least one sensing member: facilitating sensing of an at least a parameter, of a locomotory device (101) to be stationed, in real-time; and including:
an at least a radio detection and ranging sensing member (102), and an at least a sound navigation and ranging sensing member (103), said at least one radio detection and ranging sensing member (102), and said at least one sound navigation and ranging sensing member (103) sensing objects, in real-time, along a stationing path, to be taken, by said locomotory device (101), with sensed data being transmitted, to an at least a control member; and
an at least an image capturing member (104), said at least one image capturing member (104) sensing visual signals, in real-time, with an at least a user viewing sensed data, through an at least a visual interfacing member (105);
said at least one visual interfacing member (105) that is configured to act as an interface, between said locomotory device (101) to be stationed and said at least one user, with said at least one sensing member being communicatively associated with said at least one visual interfacing member (105);
said at least one control member that facilitates controlling of said locomotory device (101), with:
said at least one control member being communicatively associated with a plurality of actuators, including: brakes; accelerator; steering; and gearbox;
controlling of said gearbox comprising: a first gear control (1); a neutral gear control (N); and a reverse gear control (R);
an accelerator control (A) being configured to be actuated, only when said locomotory device (101) to be stationed is in first gear or in reverse gear;
a brake control (B) being configured to be actuated, by default, until said accelerator control (A) is actuated; and
said locomotory device (101) to be stationed being operated, by said at least one user, through said at least one control member, based on data received, by said at least one control member, and viewed, through said at least one visual interfacing member (105); and
an alert generating member that generates an at least an alert, upon said at least one control member's instructions.

2. The apparatus, for the stationing of a locomotory device, from outside the locomotory device, as claimed in claim 1, wherein:
said at least one parameter includes: distance and direction of objects, surrounding said locomotory device (101) to be stationed.

3. The apparatus, for the stationing of a locomotory device, from outside the locomotory device, as claimed in claim 1, wherein: said at least one visual interfacing member (105) is a joystick with display.

4. The apparatus, for the stationing of a locomotory device, from outside the locomotory device, as claimed in claim 1, wherein: said at least one control member is a microcontroller.

5. The apparatus, for the stationing of a locomotory device, from outside the locomotory device, as claimed in claim 1, wherein: said at least one control member is a Single Board Computer.

6. The apparatus, for the stationing of a locomotory device, from outside the locomotory device, as claimed in claim 1, wherein: said at least one control member is a System on Chip.

7. The apparatus, for the stationing of a locomotory device, from outside the locomotory device, as claimed in claim 1, wherein:
said apparatus is configured, monitored, and controlled remotely, through an application on a computing device.

8. The apparatus, for the stationing of a locomotory device, from outside the locomotory device, as claimed in claim 1, wherein:
controlling of said brakes comprises controlling of intensity and duration, for which, said brakes are applied.

9. The apparatus, for the stationing of a locomotory device, from outside the locomotory device, as claimed in claim 1, wherein:
controlling of said accelerator comprises controlling of intensity and duration, for which, an accelerator pedal is applied.

10. The apparatus, for the stationing of a locomotory device, from outside the locomotory device, as claimed in claim 1, wherein:
controlling of said steering comprises controlling of a steering's angle of rotation and/or direction of rotation.

11. The apparatus, for the stationing of a locomotory device, from outside the locomotory device, as claimed in claim 1, wherein: said apparatus is configured to be retrofitted, onto existing locomotory devices.
